(19) United States
(12) Patent Application Publication
(10) Pub. No.: US 2023/0104492 A1
(43) Pub. Date: Apr. 6, 2023

(54) Dynamic input-output pacer with artificial intelligence

(71) Applicant: MELLANOX TECHNOLOGIES, LTD., Yokneam (IL)

(72) Inventors: Gary Mataev, Haifa (IL); Shahaf Shuler, Kibbutz Lohamei Hagetaot (IL); Amit Mandelbaum, Teqoa (IL); Shridhar Rasal, Pune (IN); Oren Duer, Kohav Yair (IL); Benjamin Alexis Solomon Eli Fuhrer, Tel Aviv (IL); Evgenii Kochetov, Balakhna (RU); Gal Yefet, Haifa (IL)

(21) Appl. No.: 17/713,251

(22) Filed: Apr. 5, 2022

(30) Foreign Application Priority Data
Oct. 4, 2021 (RU) 2021128849

(51) Int. Cl. G06F 3/06; G06K 9/62; G06F 12/0891

(52) U.S. Cl. CPC G06F 3/0611; G06F 3/0656; G06F 3/0659; G06F 3/067; G06K 9/6256; G06F 12/0891; G06F 2212/1021

(57) ABSTRACT

In one embodiment, a processing apparatus includes a processor to train an artificial intelligence model to find a pacing action from which to derive a pacing metric for use in serving content transfer requests.

### RELATED APPLICATION INFORMATION

The present application claims priority from Russian Federation Patent Application S/N 2021128849 of Mellanox Technologies Ltd., filed Oct. 4, 2021, entitled “DYNAMIC INPUT-OUTPUT PACER WITH ARTIFICIAL INTELLIGENCE”, the disclosure of which is hereby incorporated herein by reference.

### FIELD OF THE INVENTION

The present invention relates to computer systems, and in particular, but not exclusively to, improving input/output performance in data communication devices.

### BACKGROUND

Solid-state drives (SSDs) are mass-storage devices that use integrated circuit memory, typically NAND-based flash memory, to store data while providing an interface that emulates traditional hard disk drives (HDDs). By comparison with HDDs, SSDs offer faster access, lower latency, and greater resistance to environmental disturbances. Therefore, SSDs are gradually replacing HDDs in many storage applications.

Because SSDs were originally designed to take the place of HDDs, they have generally used the same sorts of input/output (I/O) buses and protocols as HDDs, such as SATA, SAS and Fibre Channel. Subsequently, SSDs have become available that connect directly to the peripheral component interface bus of a host computer, such as the PCI Express® (PCIe®) bus. NVM Express (NVMe) defines a register interface, command set and feature set for PCI Express SSDs.

Advanced network interface controllers (NICs) are designed to support remote direct memory access (RDMA) operations, in which the NIC transfers data by direct memory access from the memory of one computer into that of another without involving the central processing unit (CPU) of the target computer. Although RDMA is generally used to transfer data to and from host memory (RAM), a number of attempts to adapt RDMA functionality for reading and writing data directly to and from an SSD have been described in the patent literature.

For example, U.S. Patent Application Publication 2008/0313364 describes a method for remote direct memory access to a solid-state storage device, which is said to allow direct access between memory of a client connected through a network to such a device. Similarly, U.S. Patent Application Publication 2011/0246597 describes a system in which a network interface component of a server may access a solid-state storage module of the server by a network storage access link that bypasses a central processing unit (CPU) and main memory of the server.

Additionally, smart NICs, such as the Mellanox® BlueField® data processing unit, offload critical network, security, and storage tasks from the CPU, for example, by supporting RDMA operations and directly reading or writing to attached storage devices in response to remote initiators requests.

### SUMMARY

There is provided in accordance with an embodiment of the present disclosure, a processing apparatus, including a processor to train an artificial intelligence model to find a pacing action from which to derive a pacing metric for use in serving content transfer requests.

Further in accordance with an embodiment of the present disclosure the processor is configured to train the artificial intelligence model to find the pacing action from which to derive the pacing metric for use in pacing commencement of serving of the content transfer requests in a storage sub-system.

Still further in accordance with an embodiment of the present disclosure the pacing metric is a pacing period.

Additionally in accordance with an embodiment of the present disclosure the pacing action is a change in pacing period to be applied by the storage sub-system.

Moreover, in accordance with an embodiment of the present disclosure the processor is configured to train the artificial intelligence model to find the pacing action that maximizes at least one storage sub-system parameter responsively to training data including at least one previous storage sub-system state and at least one previous pacing action.

Further in accordance with an embodiment of the present disclosure the at least one storage subsystem parameter includes one or more of the following a bandwidth, a cache hit rate, and a number of buffers in flight.

Still further in accordance with an embodiment of the present disclosure the processor is configured to train the artificial intelligence model to find the pacing action that maximizes at least one storage sub-system parameter responsively to training data including at least one window of storage sub-system states and at least one window of pacing actions.

Additionally in accordance with an embodiment of the present disclosure the processor is configured to apply the artificial intelligence model to predict a plurality of future pacing actions responsively to training data including windows of storage sub-system states and windows of pacing actions, apply the future pacing actions resulting in corresponding future storage sub-system states, compute a reward or punishment responsively to comparing values of the at least one storage sub-system parameter of the future storage sub-system states with at least one target value, and train the artificial intelligence model responsively to the reward or punishment.

Moreover, in accordance with an embodiment of the present disclosure the processor is configured to apply a storage sub-system simulation engine that simulates operation of the storage sub-system to provide the future storage sub-system states responsively to the future pacing actions.

Further in accordance with an embodiment of the present disclosure each of the future storage sub-system states includes one or more of the following a bandwidth, a cache hit rate, the pacing metric, a number of buffers in flight, a cache hit rate, the pacing metric, a number of buffers in flight, a cache eviction rate, a number of bytes waiting to be processed, a number of bytes of transfer requests received over a given time window, a difference in a number of bytes in flight over the given time window, a number of bytes of the transfer requests completed over a given time window, and a number of bytes to submit over the given time window.

Still further in accordance with an embodiment of the present disclosure the processor is configured to find the pacing action from which to derive the pacing metric for use in pacing commencement of the serving of the content transfer requests in the storage sub-system responsively to reinforcement learning.

There is also provided in accordance with another embodiment of the present disclosure, a processing apparatus, including processing circuitry to use an artificial intelligence model trained to find a pacing action from which to derive a pacing metric for use in serving content transfer requests.

Additionally in accordance with an embodiment of the present disclosure the processing circuitry is configured to use an artificial intelligence model trained to find the pacing action from which to derive the pacing metric for use in pacing commencement serving of the content transfer requests in a storage sub-system.

Moreover, in accordance with an embodiment of the present disclosure, the apparatus includes the storage sub-system, and wherein the processing circuitry is configured to pace the commencement of the serving of the content transfer requests responsively to the pacing metric, apply the artificial intelligence model to find the pacing action, and compute the pacing metric responsively to the pacing action.

Further in accordance with an embodiment of the present disclosure, the apparatus includes a network interface including one or more ports for connection to a packet data network and configured to receive the content transfer requests from at least one remote device over the packet data network via the one or more ports, and wherein the storage sub-system is configured to be connected to local peripheral storage devices, and includes at least one peripheral interface, and a memory sub-system including a cache and a random-access memory (RAM), the memory sub-system being configured to evict overflow from the cache to the RAM, and the processing circuitry is configured to manage transfer of content between at least one remote device and the local peripheral storage devices via the at least one peripheral interface and the cache, responsively to the content transfer requests, while pacing the commencement of the serving of respective ones of the content transfer requests responsively to the pacing metric so that while ones of the content transfer requests are being served, other ones of the content transfer requests pending serving are queued in at least one pending queue.

Still further in accordance with an embodiment of the present disclosure the pacing metric is a pacing period, and the pacing action is a change in the pacing period.

Additionally in accordance with an embodiment of the present disclosure the processing circuitry is configured to apply the artificial intelligence model to find the pacing action responsively to at least one previous state and at least one previous pacing action of the storage sub-system, and compute the pacing metric responsively to the pacing action.

Moreover in accordance with an embodiment of the present disclosure the at least one previous state includes one or more of the following a bandwidth of the storage sub-system, a cache hit rate of the storage sub-system, a pacing metric of the storage sub-system, and a number of buffers in flight over the storage sub-system, a cache eviction rate, a number of bytes waiting to be processed, a number of bytes of transfer requests received over a given time window, a difference in a number of bytes in flight over the given time window, a number of bytes of the transfer requests completed over a given time window, and a number of bytes to submit over the given time window.

Further in accordance with an embodiment of the present disclosure the processing circuitry is configured to apply the artificial intelligence model to find the pacing action responsively to a window of previous states and a window of previous pacing actions of the storage sub-system, and compute the pacing metric responsively to the pacing action.

Still further in accordance with an embodiment of the present disclosure each of the previous states includes one or more of the following a bandwidth of the storage sub-system, a cache hit rate of the storage sub-system, a pacing metric of the storage sub-system, a number of buffers in flight over the storage sub-system, a cache eviction rate, a number of bytes waiting to be processed, a number of bytes of transfer requests received over a given time window, a difference in a number of bytes in flight over the given time window, a number of bytes of the transfer requests completed over a given time window, and a number of bytes to submit over the given time window.

There is also provided in accordance with still another embodiment of the present disclosure, a method, including receiving training data, and training an artificial intelligence model to find a pacing action from which to derive a pacing metric for use in serving content transfer requests.

There is also provided in accordance with still another embodiment of the present disclosure, a method to use an artificial intelligence model trained to find a pacing action from which to derive a pacing metric for use in serving content transfer requests, the method including applying the artificial intelligence model to find the pacing action, and computing the pacing metric responsively to the pacing action.

There is also provided in accordance with still another embodiment of the present disclosure, a software product, including a non-transient computer-readable medium in which program instructions are stored, which instructions, when read by a central processing unit (CPU), cause the CPU to receive training data, and train an artificial intelligence model to find a pacing action from which to derive a pacing metric for use in serving content transfer requests.

There is also provided in accordance with still another embodiment of the present disclosure, a software product, including a non-transient computer-readable medium in which program instructions are stored, which instructions, when read by a central processing unit (CPU), cause the CPU to apply an artificial intelligence model to find a pacing action, and compute a pacing metric for use in serving content transfer requests, responsively to the pacing action.

### BRIEF DESCRIPTION OF THE DRAWINGS

The present invention will be understood from the following detailed description, taken in conjunction with the drawings in which:

FIG. 1 is a block diagram view of a data communication system constructed and operative in accordance with an embodiment of the present invention;

FIG. 2 is a flowchart including steps in a method to provide storage sub-system congestion control in the system of FIG. 1;

FIG. 3 is a flowchart including steps in a method to perform pacing in the system of FIG. 1;

FIG. 4 is a block diagram to illustrate pacing of content transfer requests in the system of FIG. 1;

FIG. 5 is a flowchart including steps in a method to provide data-capacity credits in the system of FIG. 1;

FIG. 6 is a flowchart including steps in a method to perform pacing using data-capacity credits in the system of FIG. 1;

FIG. 7 is a flowchart including steps in a method to perform pacing based on data-throughput rates in the system of FIG. 1;

FIG. 8 is a flowchart including steps in a method to provide data-throughput rate credits in the system of FIG. 1;

FIG. 9 is a flowchart including steps in a method to perform pacing using data-throughput rate credits in the system of FIG. 1;

FIG. 10 is a block diagram view of the data communication system of FIG. 1 exporting log data to a processing apparatus for training an artificial intelligence model;

FIG. 11 is a block diagram view of a more detailed view of a processor of the processing apparatus of FIG. 10;

FIG. 12 is a flowchart including steps in a method to train the artificial intelligence model of FIG. 10;

FIG. 13 is a flow diagram illustrating an example method to train the artificial intelligence model of FIG. 10;

FIG. 14 is a block diagram view of the processor of FIG. 11 illustrating use of the trained artificial intelligence model of FIG. 10;

FIG. 15 is a flowchart including steps in a method to use the trained artificial intelligence model of FIG. 10;

FIG. 16 is a block diagram view of the processor of FIG. 11 illustrating training of a pacing artificial intelligence model;

FIG. 17 is a flowchart including steps in a method to train the pacing artificial intelligence model of FIG. 16;

FIG. 18 is a flow diagram illustrating an example method to train the pacing artificial intelligence model of FIG. 16;

FIG. 19 is a is a block diagram view of the data communication system of FIG. 1 receiving weights and/or code for use in a trained pacing artificial intelligence model;

FIG. 20 is a flowchart including steps in a method to use the trained pacing artificial intelligence model of FIG. 19; and

FIG. 21 is a flow diagram illustrating an example method to use the trained pacing artificial intelligence model of FIG. 19.

### DESCRIPTION OF EXAMPLE EMBODIMENTS

### Overview

As previously mentioned, some data communication devices such as smart NICs (e.g., Mellanox® BlueField® data processing unit) support directly reading or writing to attached local peripheral storage devices (e.g., NVM express (NVMe) drives) via a storage sub-system in response to remote initiator requests (e.g., content transfer requests received from devices over a network to which the data communication device is connected).

Depending on the level of content transfer requests and the speed and bandwidth of the network, storage sub-system interfaces and the local peripheral storage devices, the storage sub-system may suffer from congestion leading to a deterioration in system response to serving the incoming content transfer requests.

For example, the storage sub-system may include a random-access memory (RAM) (e.g., Double Data Rate (DDR) memory) which is used to transfer content between the data communication device and the local peripheral storage devices, and vice-versa. In some cases, the RAM is not the bottleneck as the local peripheral storage devices are slow. In other cases, where the peripheral storage devices are fast enough (e.g., NVMe drives), the RAM may become the bottleneck as it is slower than the local peripheral storage devices and the network ports serving the initiators of the content transfer requests.

One method to solve this problem is to use a cache (e.g., last level cache (LLC)) in which to copy data between the data communication device and the local peripheral storage devices, and vice-versa. However, if the cache becomes full, cache entries (which still need to be used) may be evicted to the RAM (for example, on a least recently used (LRU) basis). The evicted entries then need to be read from RAM to the cache, when necessary, leading to a bottleneck. In general, the cache may be selected to service the network bandwidth and if the data communication device is successful in keeping all entries (that need to be used) in the cache then the cache can service the content transfer requests at full wire speed. However, once entries are evicted from the cache to the RAM, a vicious cycle may be formed in which it can take a long time to return to optimal performance where no entries (that need to be used) are evicted from the cache.

Therefore, in some cases, if all received content transfer requests are served, the cache becomes a bottleneck and cache entries (which still need to be used) are evicted to RAM. One solution is to request initiators to refrain from sending content transfer requests. However, this solution is generally not practical as initiators may be from different entities or otherwise non-compliant.

In some scenarios, other interfaces in the storage sub-system, such as PCIe interfaces may become the transfer bottleneck. For example, each NVMe drive has a given input/output (I/O) rate and given bandwidth limitations. If too many requests are sent to an NVMe drive, the requests may become out-of-order on the NVMe drive resulting in high latency and degradation in performance. In such a situation, although the PCIe interface may handle the level of requests, the relevant buffers are filled with data which could be better used by another I/O device.

One solution to the above problems is to provide a data communication apparatus (e.g., NIC or smart NIC) which manages transfer of content between remote device(s) and local peripheral storage devices (e.g., NVMe drives) over a storage sub-system, responsively to content transfer requests received from the remote device(s), while pacing commencement of serving the content transfer requests responsively to at least one metric of the storage sub-system so that while some content transfer requests are being served, other content transfer requests pending serving are queued in one or more pending queues. The metric(s) may include a data capacity of a cache and/or data-throughput rates of the storage sub-system (e.g., of the peripheral interfaces).

One possible pacing solution includes pacing according to the I/O rates of respective I/O devices (e.g., I/O interfaces). For example, data-throughput rate credits are assigned to the respective peripheral interfaces so that use of the respective peripheral interfaces is limited to availability of respective data-throughput rate credits for a given pacing period. For example, if there are three peripheral interfaces with data-throughput rates (e.g., I/O rates) of X GB per second, Y GB per second and Z GB per second, and the wire speed is greater than X plus Y plus Z, then content transfer requests may be queued in three respective pending queues for the three peripheral interfaces according to which peripheral interface the content transfer requests should be directed, and the three respective pending queues may be allocated A, B and C credits in proportion to X, Y and Z, respectively, for the given pacing period. The requests in the pending queues are then served according to the available data-throughput rate credits of the respective pending queues.

The above pacing solution may be sub-optimal if the pacing period or other pacing metrics are not set correctly. Additionally, the optimal pacing period (or other metric) may change over time responsively to changing hardware factors and changing traffic patterns. Different customers may have different storage device configurations and therefore the pacer(s) for each installation needs to be customized. Therefore, the pacer(s) cannot have uniform pacer parameters in different installations.

Therefore, embodiments of the present invention solve the above problems by training a pacing artificial intelligence (AI) model to find a pacing action from which to derive a pacing metric (e.g., pacing period) for use in a storage sub-system of data communication device. The pacing AI model is trained to find the pacing action which maximizes one or more performance parameters (e.g., bandwidth, cache usage, bytes in flight) of the storage sub-system. The pacing AI model may be trained using any suitable AI technique, for example, reinforcement learning. The pacing Al model may be trained based on training data including storage sub-system states and actions provided by the storage sub-system in an online manner (e.g., directly from the storage sub-system while it is running) or in an offline manner, for example, using data communication device simulation engine, described below, which simulates changes in state of the storage sub-system based on input state(s) and optionally actions.

In some embodiments, the pacing action may include how to change the pacing metric, e.g., the pacing period, i.e., whether to increase or decrease the pacing period.

In some embodiments, the pacing metric may include a speed threshold so that the pacing action may include changing the speed threshold (i.e., increasing or decreasing the speed threshold). For example, devices having a speed above a given speed threshold may be included with the group of devices subject to pacing, whereas devices having a speed below the given speed threshold may be excluded from the group of devices subject to pacing. Therefore, the pacing action may result in devices being included or excluded from the group of devices subject to pacing.

In some embodiments, the pacing metric may include a cache size to allocate for use by the group of devices subject to pacing when transferring over the storage sub-system. Therefore, the pacing action may include increasing or decreasing the cache size used by the group of devices subject to pacing when transferring over the storage sub-system.

The trained pacing AI model is then used to find a pacing action from which to derive a pacing metric for use in commencement of serving content transfer requests in the storage sub-system.

Due to the complexities of the storage sub-system, the high processing speeds, and a lack of software infrastructure desirable for training an AI model of the data communication device, it may be more convenient to train the pacing AI model offline remotely from the storage sub-system using software which simulates operation of the storage sub-system. Therefore, in some embodiments, the pacing AI model is trained from data provided by data communication device simulation engine, which has been trained to simulate operation of the storage sub-system. The data communication device simulation engine may be trained using log data provided by data communication device, for example, based on one or more states of the storage sub-system and optionally one or more actions performed by the storage sub-system derived from the log data.

In some embodiments, the data communication device simulation engine may be trained to simulate other functionality of the data communication device outside of the storage sub-system. In some embodiments, the data communication device simulation engine may be used to train the pacing AI model or any other suitable AI model. In some embodiments, the data communication device simulation engine may be used to investigate operation of the data communication device, for example, to identify problems with the data communication device or fine tune parameters of the data communication device.

### System Description

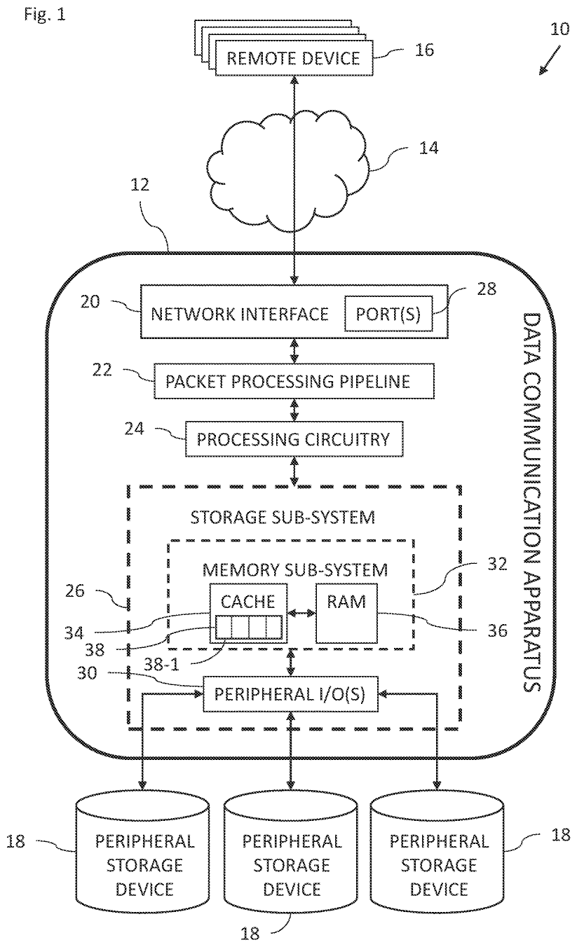

Reference is now made to FIG. 1, which is a block diagram view of data communication system 10 constructed and operative in accordance with an embodiment of the present invention. The data communication system 10 includes data communication apparatus 12, which receives content transfer requests over a packet data network 14 from one or more remote devices 16. The content transfer requests may be RDMA requests by way of example only. In response to the content transfer requests, the data communication apparatus 12 reads data front, and/or writes data to, (local peripheral) storage devices 18 (e.g., NVMe drives) connected to the data communication apparatus 12. For example, the data communication apparatus 12 is configured to receive data from the remote device(s) 16 to be written to the local peripheral storage device(s) 18 and/or send data read from the local peripheral storage device(s) 18 to the remote device(s) 16.

The data communication apparatus 12 includes a network interface 20, a packet processing pipeline 22, processing circuitry 24, and a storage sub-system 26. The network interface 20 includes one or more ports 28 for connection to the packet data network 14. The packet processing pipeline 22 is configured to process received network packets and to process data for sending in packets over the network 14. The packet processing pipeline 22 may include a PHY chip and a MAC chip, among other components.

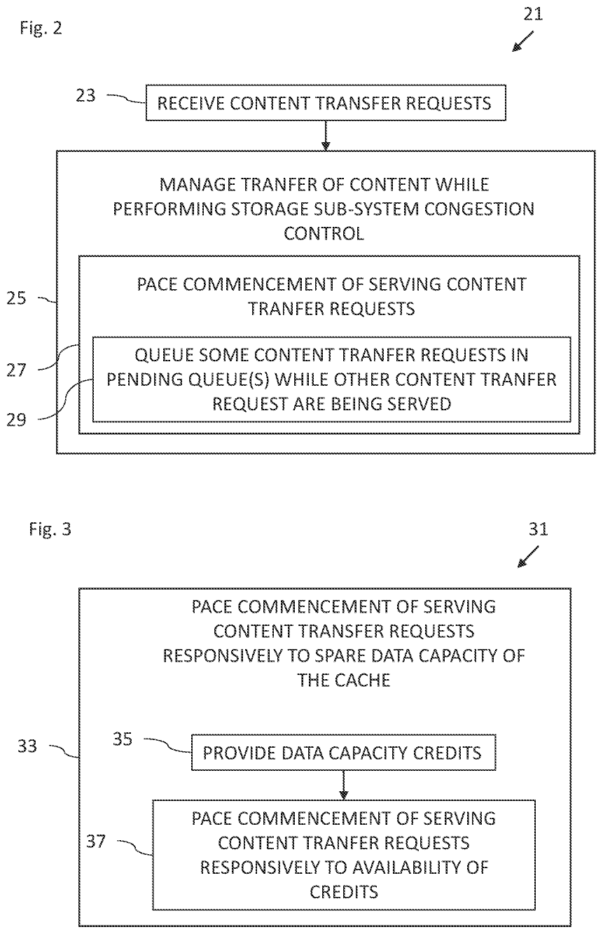

The processing circuitry 24 may further process received packet data for example, received content transfer requests. The processing circuitry 24 may comprise one or more processors, for example, tile processors, or an array of ARM processors. The functionality of the processing circuitry 24 is described in more detail with reference to FIGS. 2-9 below.

In practice, some or all of the functions of the processing circuitry 24 may be combined in a single physical component or, alternatively, implemented using multiple physical components. These physical components may comprise hard-wired or programmable devices, or a combination of the two. In some embodiments, at least some of the functions of the processing circuitry 24 may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The storage sub-system 26 includes a memory sub-system 32 and one or more peripheral interfaces 30. The storage sub-system 26 is configured to be connected to the local peripheral storage devices 18 via the peripheral interface(s) 30, for example, PCIe interfaces. The memory sub-system 32 includes a cache 34 and a random-access memory (RAM) 36. The memory sub-system 32 is configured to evict overflow from the cache 34 to the RAM 36. Data is read by the local peripheral storage devices 18 and written by from the local peripheral storage devices 18 via the cache 34 and the peripheral interfaces 30. For example, while serving a particular content transfer request, the data written to, or read from, one of the local peripheral storage devices 18 is transferred via a section 38 of the cache 34. The same section 38 (e.g., the same cache line or same cache lines) of cache 34 may be used to transfer several data chunks associated with the same content transfer request one after the other. For example, a first data chunk of a content transfer request is read from one of the local peripheral storage devices 18 to the section 38-1 of the cache 34, and then copied from the section 38-1 of the cache 34 to the packet processing pipeline 22 for sending over the network 14 to the initiator of the content transfer request, then a second data chunk of that content transfer request is read from the same local peripheral storage devices 18 to the same section 38-1 of the cache 34, and then copied from that section 38-1 of the cache 34 to the packet processing pipeline 22 for sending over the network 14 to the initiator of the content transfer request, and so on. In other embodiments, different sections 38 of the cache 34 may be used to transfer different chunks associated with the same content transfer request.

Reference is now made to FIG. 2, which is a flowchart 21 including steps in a method to provide storage sub-system congestion control in the system 10 of FIG. 1. Reference is also made to FIG. 1. The network interface 20 is configured to receive (block 23) content transfer requests from the remote device(s) 16 over the packet data network 14 via the one or more ports 28. The content transfer requests are processed by the packet processing pipeline 22 and received by the processing circuitry 24.

The processing circuitry 24 is configured to manage transfer (block 25) of content between the remote device(s) 16 and the local peripheral storage devices 18, responsively to the content transfer requests, while performing storage sub-system congestion control of the storage sub-system 26 transparently to the storage sub-system 26.

In some embodiments, the processing circuitry 24 is configured to manage transfer of content between the remote device(s) 16 and the local peripheral storage devices 18 via the peripheral interface(s) 30 and the cache 34, responsively to the content transfer requests. The step of block 25 is performed while pacing (block 27) commencement of serving the content transfer requests responsively to one or more metrics of the storage sub-system 26 so that while some content transfer requests are being served, other content transfer requests pending serving are queued in at least one pending queue (block 29). The term “commencement of serving”, as used in the specification and claims, is defined as the processing circuitry 24 initiating transferring requested data by the storage sub-system 26 in response to one of the content transfer requests so that none of the data requested in that content transfer request in transferred until the commencement of serving of that content transfer request. In other words, initiation of transferring data requested in a content transfer request is performed responsively to the metric(s) of the storage sub-system 26 (e.g., the cache 34 and/or the peripheral interfaces 30). The metric(s) may include a data capacity of the cache 34 and/or data-throughput rates of the storage sub-system 26 (e.g., of the peripheral interfaces 30).

Reference is now made to FIG. 3, which is a flowchart 31 including steps in a method to perform pacing in the system 10 of FIG. 1. Reference is also made to FIG. 1. The processing circuitry 24 is configured to pace (block 33) the commencement of the serving of respective ones of the content transfer requests responsively to spare data capacity of the cache 34.

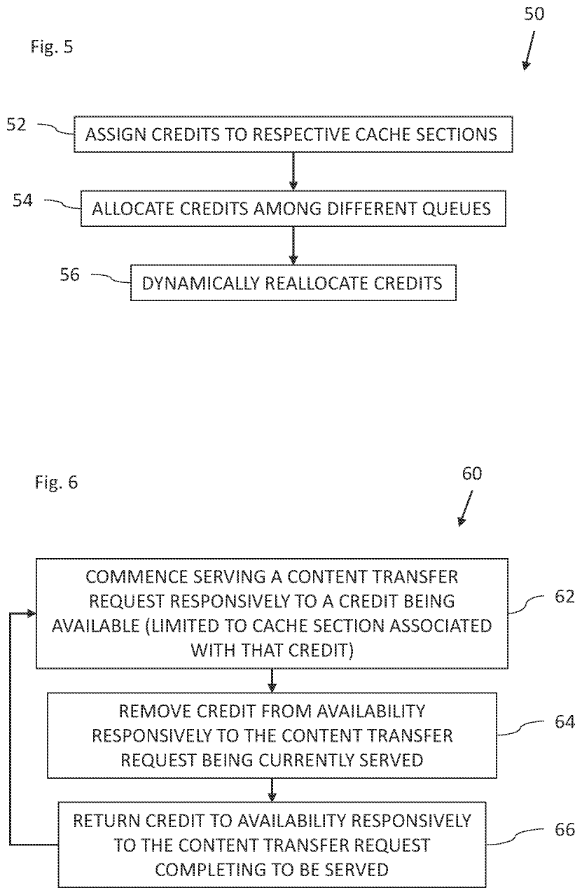

The processing circuitry 24 is configured to provide (block 35) data-capacity credits responsively to the size of the cache. For example, if the cache has X sections 38 which may be used for simultaneously serving X respective content transfer requests, then the processing circuitry 24 is configured to provide X data-capacity credits. The step of block 35 is described in more detail with reference to FIG. 5. The processing circuitry 24 is configured to pace (block 37) the commencement of the serving of the respective content transfer requests responsively to availability of the data-capacity credits. The step of block 37 is described in more detail with reference to FIG. 6.

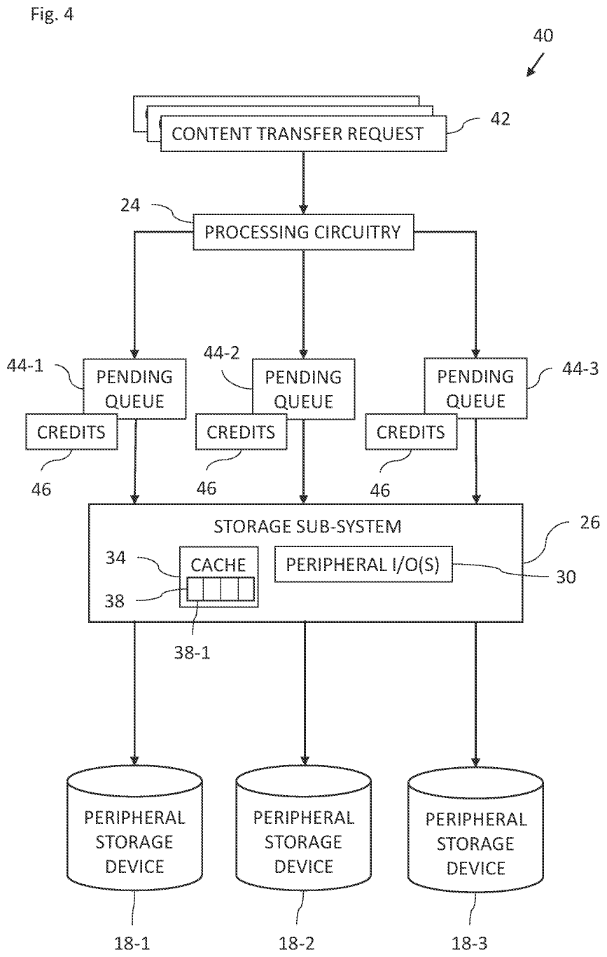

Reference is now made to FIGS. 4 and 5. FIG. 4 is a block diagram 40 to illustrate pacing of serving content transfer requests 42 in the system 10 of FIG. 1. FIG. 5 is a flowchart 50 including steps in a method to provide data-capacity credits 46 in the system 10 of FIG. 1.

As previously mentioned, the cache 34 includes respective cache sections 38. The processing circuitry 24 may be configured to assign (block 52) respective data-capacity credits 46 to the respective cache sections 38 so that use of the respective cache sections 38 is limited to availability of the respective data-capacity credits 46. For example, if the cache 34 has n cache sections, e.g., S1 to Sn, the processing circuitry 24 assigns n data-capacity credits 46, C1 to Cn corresponding to the n cache sections 38. If the data-capacity credit C2 is available for serving one of the content transfer requests 42, the cache section S2 is then used to serve that request.

In some embodiments, all the content transfer requests are queued in a single pending queue 44 and that queue is assigned all of the available data-capacity credits 46. In some embodiments, there are different pending queues 44 and the processing circuitry 24 is configured to allocate (block 54) the provided data-capacity credits 46 among the different pending queues 44. For example, credits C1 to C5 are allocated to pending queue 44-1, credits C6 to C10 are allocated to pending queue 44-2, and credits C11 to C15 are allocated to pending queue 44-3. The credits may be allocated to the different queues equally or unequally, for example, according to known or expected demand on those queues. FIG. 4 shows three pending queues 44 corresponding to three local peripheral storage devices 18 so that each pending queue 44 services the corresponding local peripheral storage device 18. For example, content service requests 42 for local peripheral storage device 18-1 are queued in pending queue 44-1, content service requests 42 for local peripheral storage device 18-2 are queued in pending queue 44-2, and so on. The credits 46 assigned to pending queue 44-1 are used, when available, by the content transfer requests 42 being queued in the pending queue 44-1, and so on. For example, when one of the content transfer requests 42 which was being queued in pending queue 44-1 is being served, one of the available data-capacity credits 46 allocated to pending queue 44-1 is removed from availability, and is returned to availability for use by the content transfer requests 42 of pending queue 44-1 when the content transfer request 42 has completed to be served, as described in more detail with reference to FIG. 6.

The example, of FIG. 4 shows one pending queue 44 associated with each local peripheral storage device 18. In some embodiments, each of the local peripheral storage devices 18 may be associated with a read and write queue.

The different pending queues 44 may comprises any one or more of the following: a read pending queue and a write pending queue; pending queues for different ones of the local peripheral storage devices 18; pending queues for different groups of the local peripheral storage devices 18; pending queues for different peripheral interfaces 30; pending queues for different content request attributes; or pending queues for different content request initiators.

The initial allocation of the credits 46 among the different queues 44 may be non-optimal. For example, if there are different queues 44 for different local peripheral storage devices 18, and one or more of the local peripheral storage devices 18 are slower than the other devices 18, then it may be more efficient to provide less credits 46 to the slower device(s) 18. Another example may be drives experiencing errors. Therefore, in some embodiments, the processing circuitry 24 is configured to analyze credit usage by the different pending queues 44 (for example on a round-robin basis) and dynamically reallocate (block 56) the data-capacity credits 46 among the different pending queues 44 responsively to usage of the credits 46 by the different pending queues 44. If credits 46 are being used quickly, it is an indication the associated local peripheral storage device(s) 18 are working efficiently and should be assigned more credits 46 than slower local peripheral storage device(s) 18 that are using the credits more slowly.

Reference is now made to FIG. 6, which is a flowchart 60 including steps in a method to perform pacing using the data-capacity credits 46 in the system 10 of FIG. 1. Reference is also made to FIG. 4.

The processing circuitry 24 is configured to receive the content transfer requests 42 from the packet processing pipeline 22 (FIG. 1) and assign the content transfer requests 42 to respective pending queues 44 responsively to the content transfer requests 42. For example, a request to read content from, or write content to, the local peripheral storage device 18-1 will be queued in pending queue 44-1, and so on.

The processing circuitry 24 is configured to commence serving (block 62) one of the content transfer requests 42 responsively to one of the data-capacity credits 46 being available (for the pending queue 44 in which that content transfer request 42 is queued). The processing circuitry 24 is configured to remove (block 64) the available data-capacity credit 46 from availability responsively to that content transfer request 42 being currently served. The processing circuitry 24 is configured to return (block 66) the removed data-capacity credit 46 to availability responsively to that content transfer request 42 completing to be served.

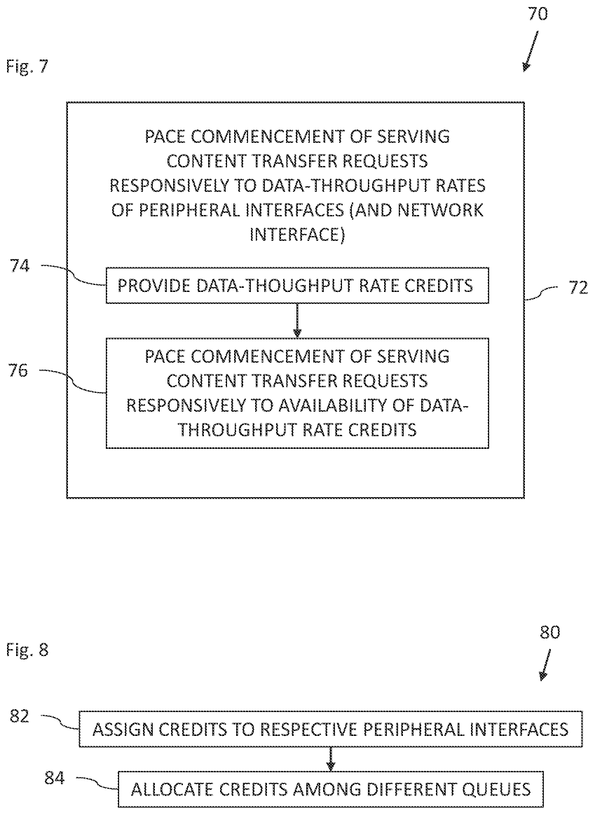

Reference is now made to FIG. 7, which is a flowchart 70 including steps in a method to perform pacing based on data-throughput rates in the system 10 of FIG. 1. Reference is also made to FIG. 1. The processing circuitry 24 is configured to pace (block 72) the commencement of the serving of respective content transfer requests responsively to the data-throughput rates (e.g., I/O rates) of the respective peripheral interfaces 30 and the network interface 20.

The processing circuitry 24 is configured to provide (block 74) data-throughput rate credits responsively to the data throughput rates of the peripheral interfaces 30 and the wire speed. If the cumulative data throughput rates of the peripheral interfaces 30 are greater than the wire speed, the overall data throughput rate is limited by the wire speed, otherwise the overall data throughput rate is limited by the data throughput rates of the peripheral interfaces 30. The processing circuitry 24 is configured to pace (block 76) the commencement of the serving of the respective content transfer requests responsively to availability of the data-throughput rate credits (per pending queue). For example, every fixed time period a credit (or credits) is allocated to perform an input/output operation of a specific size. In some embodiments, different pending queues may be allocated a different number of credits per fixed time period. In other embodiments, the same number of credits may be assigned to each pending queue. In some embodiments, the fixed time period or the size of the input/output operation may be the same per pending queue or different for different pending queues.

By way of example, using rounded numbers, for an available data throughput rate of 200 Gigabits per second for one or more of the peripheral interfaces 30, allow a total content transfer of 128 Kilobytes via the peripheral interface(s) 30 to be executed every 5 microseconds. Therefore, each 5 microseconds, the pending queue is analyzed and content transfer requests requesting in total up to 128 Kilobytes of data transfer are commenced to be served. Other requests are left in the pending queue for future serving when a new credit is available in 5 or 10 microseconds for example.

For example, if there are three peripheral interfaces 30 with data-throughput rates (e.g., I/O rates) of X GB per second, Y GB per second and Z GB per second, and the wire speed is greater than X plus Y plus Z, then content transfer requests may be queued in three respective pending queues for the three peripheral interfaces 30 according to which respective peripheral interface 30 the content transfer requests should be directed, and the three respective pending queues (of the three peripheral interfaces 30) may be allocated A, B and C credits in proportion to X, Y and X, respectively.

Reference is now made to FIG. 8 is a flowchart 80 including steps in a method to provide data-throughput rate credits in the system 10 of FIG. 1. Reference is also made to FIG. 1. The processing circuitry 24 is configured to assign (block 82) respective ones of the data-throughput rate credits to the respective peripheral interfaces 30 (intermittently, e.g., periodically) so that use of the respective peripheral interfaces 30 is limited to availability of respective data-throughput rate credits. For example, the data-throughput credits assigned to one of the peripheral interfaces 30 are for use by content transfer requests that will use that peripheral interface to transfer data, and so on. In some embodiments, the data throughput rate credits may be assigned to different groups of peripheral interfaces 30.

In some embodiments, the processing circuitry 24 is configured to allocate (block 84) the provided data-throughput rate credits among the different pending queues (intermittently, e.g., periodically). The different pending queues may comprise any one or more of the following: a read pending queue and a write pending queue; pending queues for different ones of the local peripheral storage devices 18; pending queues for different groups of the local peripheral storage devices 18; pending queues for different ones of the peripheral interfaces 30; pending queues for different content request attributes; or pending queues for different content request initiators. For example, there may be a pending queue for each peripheral interface 30, or a pending read queue and a pending write queue for each peripheral interface 30.

The processing circuitry 24 is configured to analyze usage of the credits by the different pending queues (e.g., on a round-robin basis) and allocate the data-throughput rate credits among the different pending queues responsively to the actual rates at which the data associated with the content transfer requests in the pending queues is transferred and other metrics.

The processing circuitry 24 is configured to pace the content transfer requests in accordance with some “pacing rate”. The pacing is generally not fixed, and has a feedback that may increase or decrease it. The feedback may be based on different current parameters of the data communication apparatus 12.

In some embodiments, the processing circuitry 24 may measure the actual achieved data-throughput rate of the data communication apparatus 12. If the pacing rate is higher than the measured achieved data-throughput rate, this would lead to an increase of in-flight data and eventually cache evictions and trashing of data. Therefore, the pacing rate is reduced to match the actual measured rate. Nevertheless, the pacing rate is adjusted to by to increase the pacing rate back to the maximum theoretical rate, since the transient effect that made the actual rate lower may have passed.

In other embodiments, the processing circuitry 24 may measure the known in-flight data in the data communication apparatus 12. If the total in-flight data is increasing, it implies that the actual achieved data-throughput rate is lower than the current pacing rate, and therefore the pacing rate is reduced. When total in-flight data in the data communication apparatus 12 is reduced, the pacing rate can be increased again.

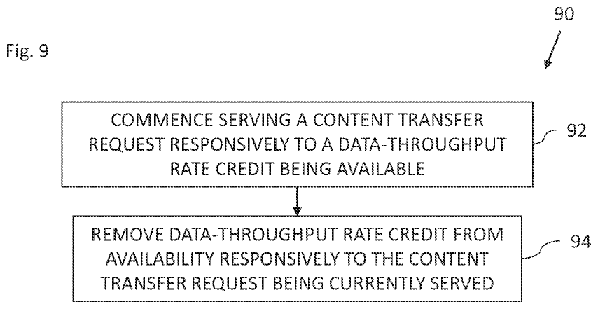

Reference is now made to FIG. 9, which is a flowchart 90 including steps in a method to perform pacing using data-throughput rate credits in the system 10 of FIG. 1. The processing circuitry 24 (FIG. 1) is configured to commence serving (block 92) one or more of the content transfer requests responsively to one of the data-throughput rate credits being available (for the pending queue in which that content transfer request is queued). The processing circuitry 24 is configured to remove (block 94) the available data-throughput rate credit from availability responsively to that content transfer request being currently served.

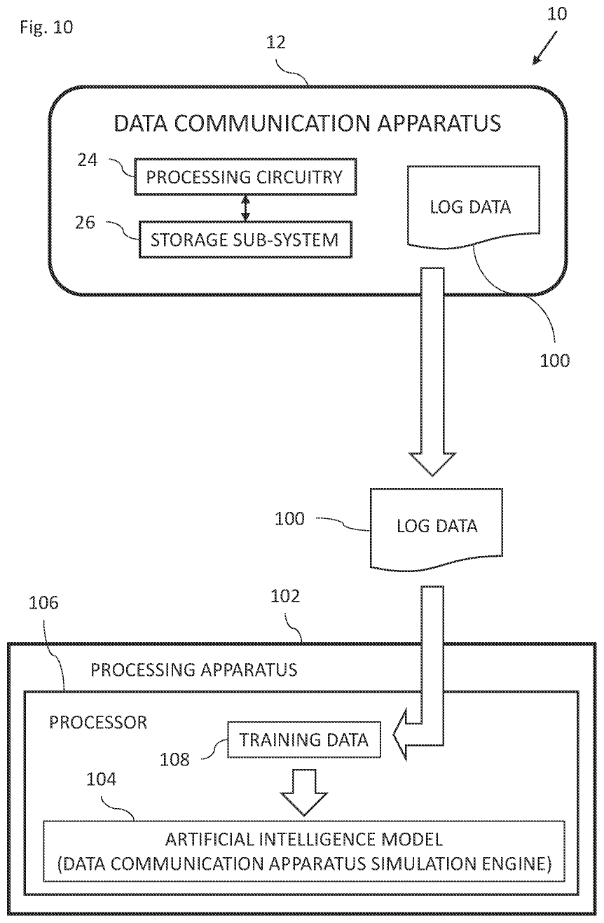

Reference is now made to FIG. 10, which is a block diagram view of data communication system 10 of FIG. 1 exporting log data 100 to a processing apparatus 102 for training an artificial intelligence model 104 as a data communication apparatus simulation engine.

The data communication apparatus 12 is run according to different scenarios while changing a duration of the pacing period, e.g., changing the duration of the pacing period linearly, non-linearly, randomly, and leaving the pacing period constant etc. The term “pacing period”, as used in the specification and claims, is defined as, a time period for which data throughput credits are allocated to perform input/output operations, and once the pacing period expires new data throughput credits are allocated to perform input/output operations in the next pacing period.

The state of the data communication apparatus 12 (including the state of the storage sub-system 26) is sampled periodically, for example, every 10 milliseconds, and the sampled states are saved as log data 100. Only some of the elements of the data communication apparatus 12 are shown in FIG. 10 for the sake of simplicity.

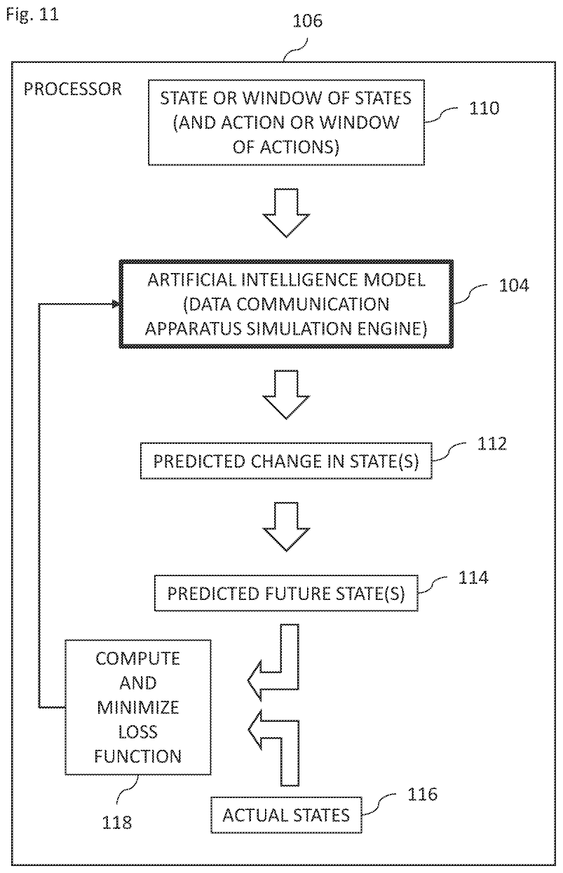

The processing apparatus 102 includes a processor 106, which receives the log data 100, derives training data 108 from the log data 100, and trains the artificial intelligence model 104, as described in more detail with reference to FIGS. 11-13.

Reference is now made to FIG. 11, which is a block diagram view of a more detailed view of the processor 106 of the processing apparatus 102 of FIG. 10. The artificial intelligence model 104 receives a state or window of states and optionally an action or window of actions (block 110) from the training data 108.

The action may include how to change a pacing metric such as the pacing period. The previous actions may be derived from the differences in pacing metrics (e.g., pacing period) between adjacent states. For example, if the pacing period is P1 in state 1, and P2 in state 2, then the action based on state 1 is equal to P2 less P1.

Each state of the storage sub-system 26 may include one or more of the following: a bandwidth of the storage sub-system 26; a cache hit rate of the storage sub-system; a pacing metric (e.g., pacing period); a number of buffers in flight over the storage sub-system 26; a cache eviction rate; a number of bytes waiting to be processed (a number of bytes still not completed to be served less a number of buffers in flight); a number of bytes of transfer requests received over a given time window (also known as input bandwidth); a difference in a number of bytes in flight over the given time window (also known as processed bandwidth); a number of bytes of the transfer requests completed over a given time window (also known as output bandwidth); and a number of bytes to submit over the given time window to read/write from/to the storage devices 18 (also known as input-output credit). It should be noted that the cache 34 may include one, or more than one banks. The cache hit rate may be computed for one or more of the banks, or any suitable combination of banks.

The artificial intelligence model 104 predicts one or more changes of states (block 112) based on the input state(s) and optionally action(s) of block 110. The changes of states may be predicted based on different input states or different windows of states to the artificial intelligence model 104. The changes of states may then be used to compute predicted future states (block 114). For example, if the state at time 0 is known and a change of state is output by the artificial intelligence model 104, the state at time 1 is equal to the change in state plus the state at time 0. The predicted future states (block 114) may then be compared with actual states (block 116) that are known from the training data 108 using a suitable loss function, which is then minimized (block 118) in order to train the artificial intelligence model 104.

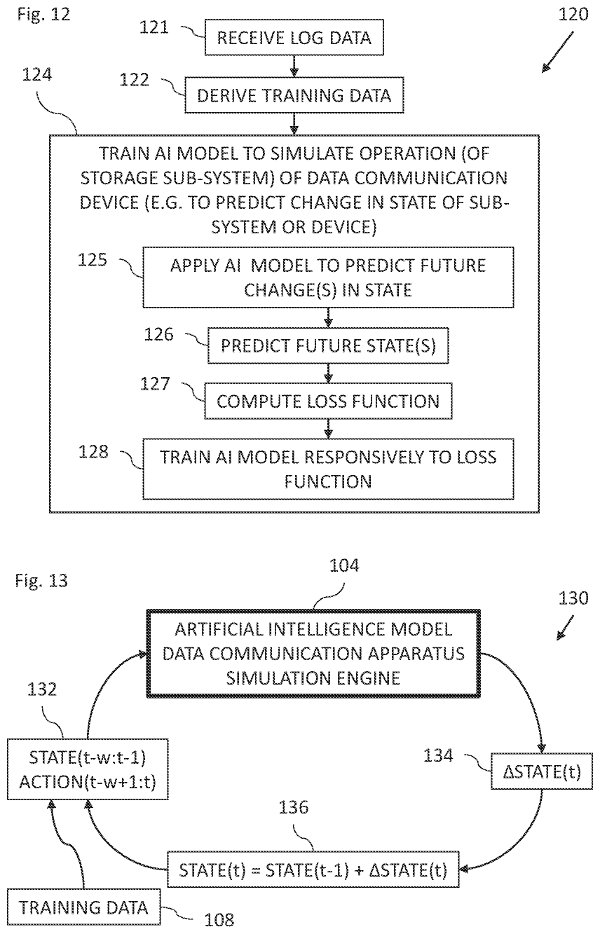

The training of the artificial intelligence model 104 is described in more detail with reference to FIGS. 12 and 13 below.

Reference is now made to FIG. 12, which is a flowchart 120 including steps in a method to train the artificial intelligence model 104 of FIG. 10.

The processor 106 is configured to receive (block 121) the log data 100 and derive (block 122) the training data 108 from the log data 100. The training data 108 includes state data of the storage sub-system 26.

The processor 106 is configured to train (block 124) the artificial intelligence model 104 as data communication apparatus simulation engine to simulate operation of the data communication apparatus 12, responsively to the training data 108 derived from the log data 100 collected about the data communication apparatus 12. In some embodiments, the processor 106 is configured to train the artificial intelligence model 104 to simulate operation of the data communication apparatus 12 responsively to the training data 108 including one or more states of the data communication apparatus 12 and optionally one or more actions performed by the data communication apparatus 12. In some embodiments, the processor 106 is configured to train the artificial intelligence model 104 to predict a change in state of the data communication apparatus 12, responsively to the training data including one or more states of the data communication apparatus 12 and optionally one or more actions performed by the data communication apparatus 12.

In some embodiments, the processor 106 is configured to train the artificial intelligence model 104 to simulate operation of the storage sub-system 26 that paces serving of content transfer requests 42 in the storage sub-system 26, responsively to the training data 108. In some embodiments, the processor 106 is configured to train the artificial intelligence model 104 to simulate operation of the storage sub-system 26 responsively to the training data 108 including one or more states of the data communication apparatus 12 and optionally one or more changes in a pacing metric (e.g., pacing period) applied by the storage sub-system 26. In some embodiments, the processor 106 is configured to train the artificial intelligence model 104 to predict a change in state of the storage sub-system 26 responsively to the training data 108 including one or more states of the data communication apparatus 12 and optionally one or more changes in a pacing metric (e.g., pacing period) applied by the storage sub-system 26.

The step of block 124 is now described in more detail with reference to the steps of blocks 125-128. The processor 106 is configured to apply (block 125) the artificial intelligence model 104 to predict a plurality of future changes in state of the data communication apparatus 12 (and/or the storage sub-system 26) responsively to training data including a window of states of the data communication apparatus (and/or the storage sub-system 26) and optionally a window of actions (e.g., changes in the pacing metric) performed by the data communication device (and/or the storage sub-system 26). The processor 106 is configured to predict (block 126) a plurality of future states of the data communication apparatus and/or the storage sub-system 26) responsively to the predicted future changes in state (found in the step of block 125). The processor 106 is configured to compute (block 127) a loss function responsively to the predicted future states and corresponding actual states of the data communication apparatus (and/or the storage sub-system 26) derived from the log data 100. In other words, if the processor 106 predicted future states for time periods 10 to 19 from a window of states from time periods 0 to 9 stored in the training data 108, actual states for time periods 10 to 19 may be extracted from the training data 108 and used to compute the loss function. The processor 106 is configured to train (block 128) the artificial intelligence model 104 responsively to the loss function, for example, by minimizing the loss function.

Reference is now made to FIG. 13, which is a flow diagram 130 illustrating an example method to train the artificial intelligence model 104 of FIG. 10.

A number of states in a window t−w to t−1, where t is a given time period and w is the size of the window, and a number of actions in a window t−w+1 tot (block 132), are extracted from the training data 108. The window of states and actions are input into the artificial intelligence model 104 yielding a predicted change in state (block 134). A predicted state at time period t may then be computed based on the state at time period t−1 plus the predicted change in state (block 136). The input data (block 132) to the artificial intelligence model 104 may then be updated by removing the oldest state and action from the window of states and actions and adding the newly computed state at time period t, and the action for time period t+1. The action for time t+1 may be derived from the difference between the state at time t and the state at time t+1, which may be derived from the training data 108. The new input data is input into the artificial intelligence model 104 yielding a new change of state for the next time period, and so on. A number of the above cycles may be performed to predict future states. The above process corresponds broadly to steps of block 125 and 126 of FIG. 12. The predicted future states may then be used to train the artificial intelligence model 104 using the loss function as described above with reference to the steps of blocks 127 and 128 of FIG. 12. The artificial intelligence model 104 may be trained based on more windows of training data taken at random or consecutively.

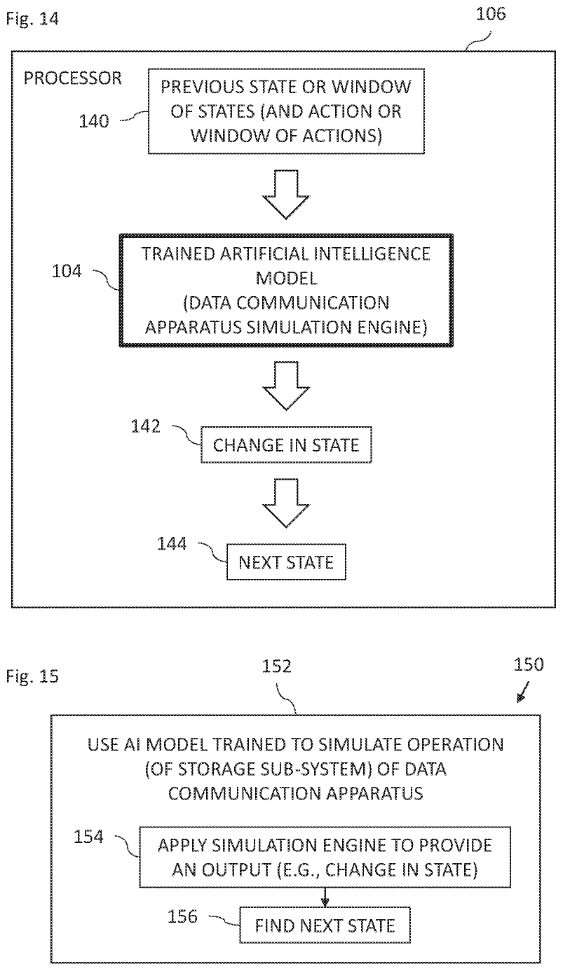

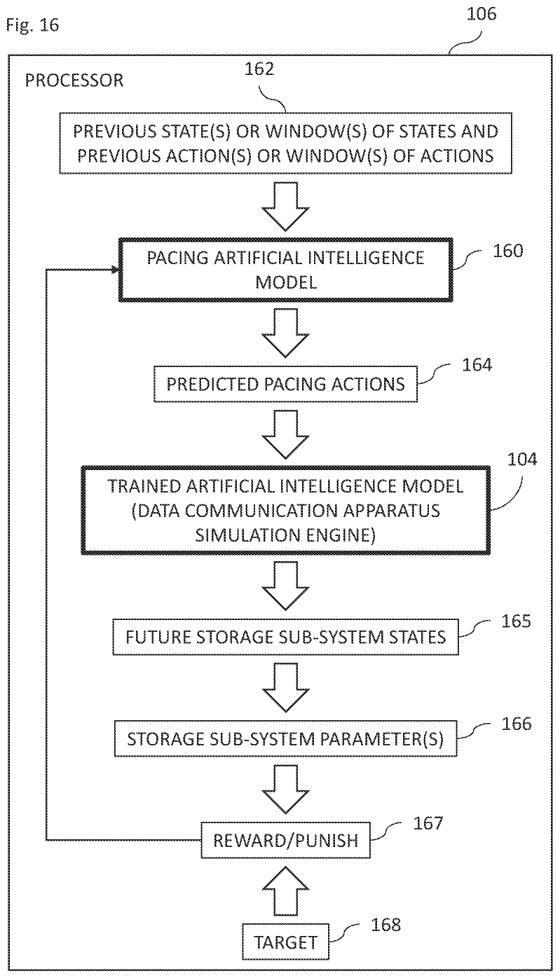

Reference is now made to FIG. 14, which is a block diagram view of the processor 106 of FIG. 11 illustrating use of the trained artificial intelligence model 104 of FIG. 10. A previous state or window of states and optionally an action of window of actions (block 140) are input into the artificial intelligence model 104 yielding a predicted change in state (block 142), which may then be used to compute a predicted new state (block 144) of the storage sub-system 26. The output of the artificial intelligence model 104 may be used to train a pacing artificial AI model, described in more detail with reference to FIGS. 16-18. In some embodiments, the artificial intelligence model 104 may be used to simulate operation of the storage sub-system 26 and/or the data communication apparatus 12 in an offline manner to identify problems or fine tune parameters of the storage sub-system 26 and/or the data communication apparatus 12.

Reference FIG. 15 is a flowchart 150 including steps in a method to use the trained artificial intelligence model 104 of FIG. 10.

The processor 106 is configured to use (block 152) the artificial intelligence model 104 trained as data communication apparatus simulation engine to simulate operation of data communication apparatus 12. In some embodiments the processor is configured to use the artificial intelligence model 104 trained as a storage sub-system simulation engine to simulate operation of the storage sub-system 26 that paces serving of content transfer requests 42 in the storage sub-system 26.

The step of block 152 is now described in more detail with reference to steps 154 and 156. The processor 106 is configured to apply (block 154) the data communication apparatus simulation engine (or the storage sub-system simulation engine) to provide an output such as a change in state of the data communication apparatus simulation engine (or the storage sub-system simulation engine) responsively to at least one input state. The input state may include the following or any suitable combination thereof: a previous state of the data communication apparatus simulation engine (or the storage sub-system simulation engine) or a window of previous states of the data communication apparatus simulation engine (or the storage sub-system simulation engine); and at least one action such as a window of previous actions applied by the data communication apparatus simulation engine (or the storage sub-system simulation engine) and/or an action to be performed by the data communication apparatus simulation engine (or the storage sub-system simulation engine). The window of previous actions may include a window of previous changes in a pacing metric applied by the storage sub-system simulation engine over time. The action to be performed by the storage sub-system simulation engine may include a change in a pacing metric to be applied by the storage sub-system engine. The processor 106 is configured to find a next state of data communication apparatus simulation engine (or the storage sub-system simulation engine) responsively to the output of the data communication apparatus simulation engine (or the storage sub-system simulation engine). For example, if the output is a change in state, then the next state may be found by adding the previous state to the change in state.

Reference is now made to FIG. 16, which is a block diagram view of the processor 106 of FIG. 11 illustrating training of a pacing artificial intelligence model 160. The pacing artificial intelligence model 160 is run on the processor 106 and is trained to provide a pacing action (e.g., how to change a pacing metric such as a pacing period) based on one or more states and optionally previous actions, using a suitable AI training method, such as reinforcement learning.

In overview, the pacing artificial intelligence model 160 outputs a pacing action based on an input of one or more states and optionally previous actions. The pacing action is then applied by the artificial intelligence model 104 to predict how the action will affect the state of the storage sub-system 26 based on simulation of the storage sub-system 26 by the artificial intelligence model 104. The new state is then input into the pacing artificial intelligence model 160 yielding a new pacing action. The above may be repeated for several rounds leading to several pacing actions predicted by the pacing artificial intelligence model 160 and several predicted states of the storage sub-system 26 predicted by the artificial intelligence model 104. The pacing artificial intelligence model 160 is then trained by rewarding or punishing the pacing artificial intelligence model 160 according to the predicted states and a target parameter value (e.g., bandwidth).

The training is now described in more detail.

The pacing artificial intelligence model 160 is trained based on: a previous state or states, or a window or windows of states; and optionally a previous action or actions, or a window or windows of actions of the data communication apparatus 12 or the storage sub-system 26 (provided by the log data 100 and/or predicted by the artificial intelligence model 104) (block 162). The pacing artificial intelligence model 160 processes the input data and predicts one or more pacing actions (block 164). The pacing artificial intelligence model 160 typically outputs one predicted action per round, as described in more detail with reference to FIG. 18. The pacing actions (block 164) may be input into the artificial intelligence model 104 along with a previous state or states, or a window or windows of states, and optionally a previous action or actions, or window or windows of actions of the data communication apparatus 12 or the storage sub-system 26 (provided by the log data 100 and/or predicted by the artificial intelligence model 104). The artificial intelligence model 104 is configured to provide data (e.g., changes in state) from which to derive future storage sub-system states (block 165). The artificial intelligence model 104 typically outputs a change in state (each round) from which a new state is derived as described in more detail with reference to FIGS. 13 and 18.

The predicted states may include values of one or more parameters of the storage sub-system 26 (e.g., bandwidth, byte in flights etc.) (block 166). The values of the parameter(s) are then compared with a target value or values (block 168). The pacing artificial intelligence model 160 is then trained by rewarding or punishing (block 167) the pacing artificial intelligence model 160 based on the comparison of the values of the parameter(s) of the predicted states and the target(s). The pacing artificial intelligence model 160 is typically trained to maximize the parameter (e.g., bandwidth) so that the values of the parameters in the future storage sub-system states are maximized within the limits of the parameter (e.g., bandwidth).

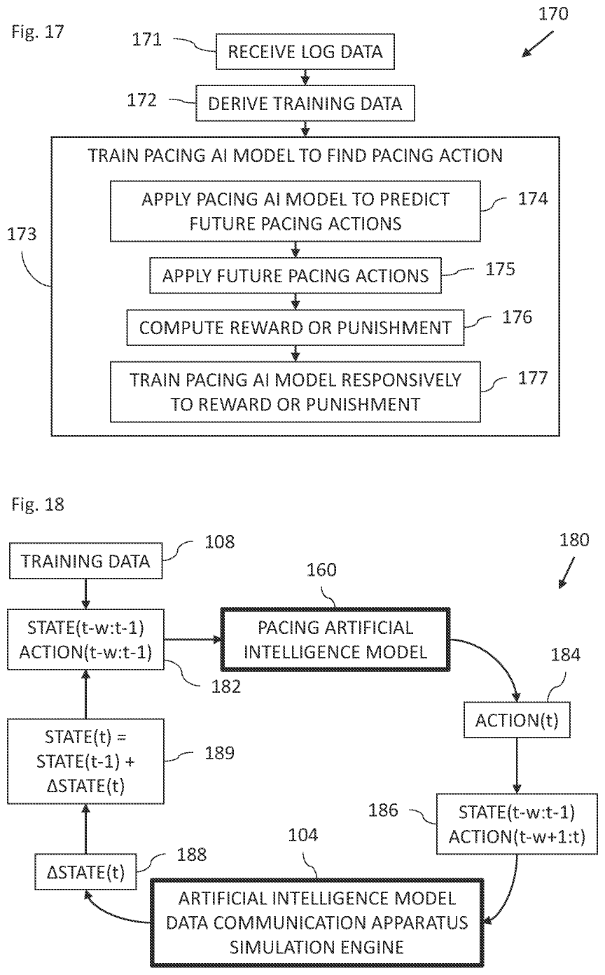

Reference is now made to FIG. 17, which is a flowchart 170 including steps in a method to train the pacing artificial intelligence model of FIG. 16.

The processor 106 is configured to receive (block 171) log data 100 and derive (block 172) training data 108 from the log data 100. The processor 106 is configured to train (block 173) the pacing artificial intelligence model 160 to find a pacing action from which to derive a pacing metric for use in pacing commencement of serving of the content transfer requests 42 in the storage sub-system 26. In some embodiments, the pacing metric is a pacing period, and the pacing action is a change in pacing period to be applied by the storage sub-system 26. In some embodiments, the processor 106 is configured to train the artificial intelligence model 160 to find the pacing action that maximizes at least one storage sub-system parameter responsively to training data. The training data may include at least one previous storage sub-system state such as one or more windows of storage sub-system states and at least one previous pacing action such as at least one window of pacing actions. In some embodiments, the processor 106 is configured to find the pacing action from which to derive the pacing metric for use in pacing commencement of the serving of the content transfer requests in the storage sub-system responsively to reinforcement learning. The step of block 173 is now described in more detail with reference to the steps of blocks 174-177.

The processor 106 is configured to apply (block 174) the artificial intelligence model 160 to predict a plurality of future pacing actions (e.g., over respective rounds of applying the pacing artificial intelligence model 160) responsively to training data which may include windows of storage sub-system states and windows of pacing actions, for example.

The processor 106 is configured to apply (block 175) the future pacing actions resulting in corresponding future storage sub-system states. In other words, in the step of block 175, the pacing actions are applied to see how they affect the storage sub-system 26 or a simulator of the storage sub-system 26. In some embodiments, the processor 106 is configured to apply the storage sub-system simulation engine (i.e., the trained artificial intelligence model 104) that simulates operation of the storage sub-system 26 to provide the future storage sub-system states responsively to the future pacing actions. Each future storage sub-system state may include one or more of the following: a bandwidth; a cache hit rate; the pacing metric; a number of buffers in flight; a cache hit rate; the pacing metric; a number of buffers in flight; a cache eviction rate; a number of bytes waiting to be processed; a number of bytes of transfer requests received over a given time window; a difference in a number of bytes in flight over the given time window; a number of bytes of the transfer requests completed over a given time window; and a number of bytes to submit over the given time window.

The processor 106 is configured to compute (block 176) a reward or punishment responsively to comparing values of a storage sub-system parameter (or parameters) of the future storage sub-system states with a target value or values. The storage sub-system parameter(s) may include one or more of the following: a bandwidth; a cache hit rate; and a number of buffers in flight. For example, if the parameter is bandwidth, the bandwidth values in the future storage sub-system states are compared with a target bandwidth to find a reward or punishment. The processor 106 is configured to train (block 177) the artificial intelligence model 160 responsively to the reward or punishment.

Reference is now made to FIG. 18, which is a flow diagram 180 illustrating an example method to train the pacing artificial intelligence model 160 of FIG. 16.

A number of states in a window t−w to t−1, where t is a given time period and w is the size of the window, and a number of actions in a window t−w to t−1 (block 182) are extracted from the training data 108. The window of states and actions are input into the pacing artificial intelligence model 160 yielding an action for time period t (block 184). The states in window t−w to t−1, and the actions in a window t−w+1 to t (based on the action output by the pacing artificial intelligence model 160) (block 186) are input into the artificial intelligence model 104, which simulates operation of the storage sub-system 26 of the data communication apparatus 12, and outputs a change in state at time period t (block 188). A predicted state at time period t may then be computed based on the state at time period t−1 plus the predicted change in state (block 189). The input data (block 182) to the artificial intelligence model 160 may then be updated by removing the oldest state and action from the window of states and actions and adding the newly computed state at time period t, and the action for time period t. The new input data is input into the artificial intelligence model 160 yielding a new action for the next time period (for time period t+1), and so on. A number of the above cycles may be performed to predict future actions and states. The above process corresponds broadly to steps of blocks 174 and 175 of FIG. 17. Values of the parameter(s) of the predicted future states may be compared to the target value(s) and a reward or punishment is computed which is then used to train the artificial intelligence model 160 as described above with reference to the steps of blocks 176 and 177 of FIG. 17. The above steps may be repeated so that the artificial intelligence model 160 may be trained based on more windows of training data taken at random or consecutively from the training data 108. For example, gradient descent may be used to change weights of the pacing artificial intelligence model 160 responsively to the reward or punishment.

In some embodiments, the pacing artificial intelligence model 160 may comprise an artificial neural network, composed of artificial neurons or nodes connected by weights. A positive weight reflects an excitatory connection, while negative values mean inhibitory connections. Inputs are modified by a weight and summed using a linear combination. An activation function may control the amplitude of the output.

In some embodiments, the pacing artificial intelligence model 160 may be trained without using the trained artificial intelligence model 104. For example, the pacing artificial intelligence model 160 may be trained in the data communication apparatus 12 using exploitation and exploration where the action is chosen to provide the maximum reward during exploitation.

The training of the artificial intelligence model 104 may be fine-tuned using more training data 108. Similarly, the pacing artificial intelligence model 160 may be fine-tuned based on an updated artificial intelligence model 104 and/or more training data 108.

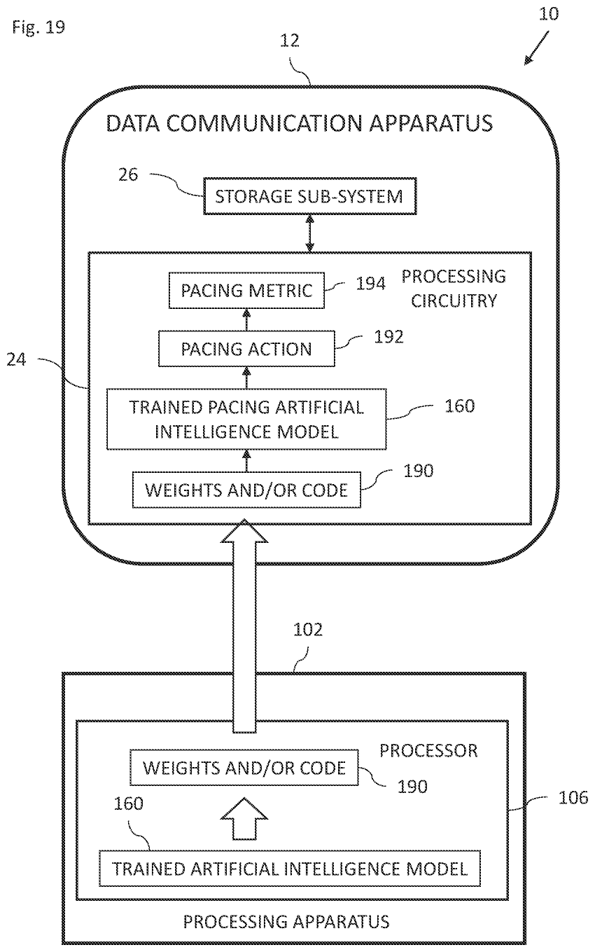

Reference is now made to FIG. 19, which is a is a block diagram view of the data communication system 10 of FIG. 1 receiving weights and/or program code 190 for use in the trained pacing artificial intelligence model 160. Once the pacing artificial intelligence model 160 is trained on the processor 106 in the processing apparatus 102, the weights and/or code 190 of the trained pacing artificial intelligence model 160 may be exported to the data communication apparatus 12 to run the pacing artificial intelligence model 160 on the processing circuitry 24 of the data communication apparatus 12. In some embodiments, the pacing artificial intelligence model 160 configured to run on the processing circuitry 24 may already include the AI model structure and program code to run the pacing artificial intelligence model 160 and therefore the weights may be transferred from the processing apparatus 102 without the program code. The program code may be implemented in a suitable library, for example, a Storage Performance Development Kit (SPDK) library. FIG. 19 shows the weights and/or code 190 being exported from the processing apparatus 102 to data communication apparatus 12. The pacing artificial intelligence model 160 may be applied to output a pacing action 192 responsively to one or more input states and optionally actions and the weights and code 190. The processing circuitry 24 may compute a pacing metric 194 (e.g., pacing period) responsively to the pacing action 192 (e.g., a change in pacing period) and the previous pacing metric (e.g., previous pacing period). The newly computed pacing period may then be used by the processing circuitry 24 to pace the serving of content transfer requests 42 over the storage sub-system 26.

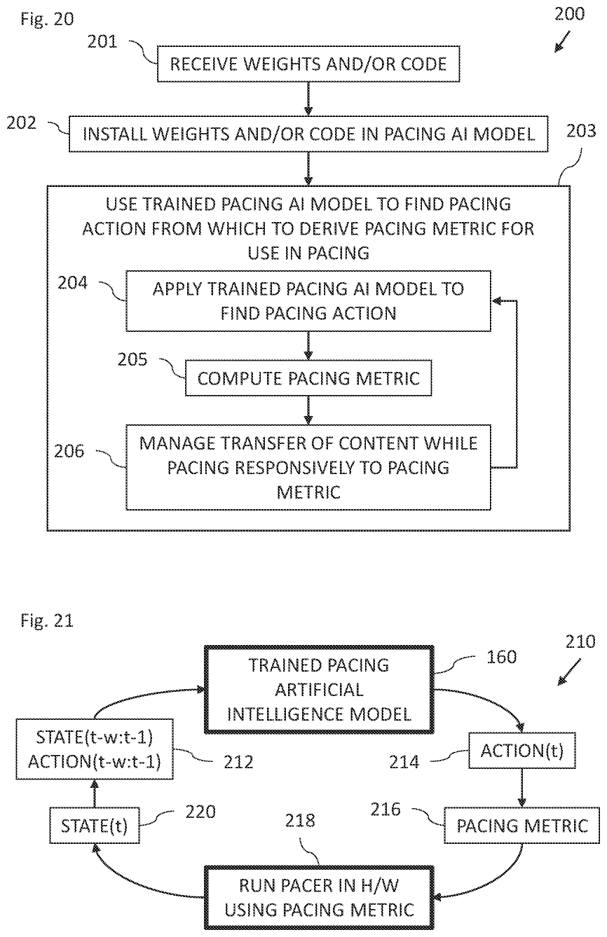

Reference is made to FIG. 20, which is a flowchart 200 including steps in a method to use the trained pacing artificial intelligence model 160 of FIG. 19.

The processing circuitry 24 is configured to receive (block 201) the weights and/or code 190 and install (block 202) the weights and/or code 190 in the pacing artificial intelligence model 160 running on the processing circuitry 24.

The processing circuitry 24 is configured to use (block 203) the pacing artificial intelligence model 160 trained to find the pacing action 192 from which to derive the pacing metric 194 for use in pacing commencement serving of the content transfer requests 42 in the storage sub-system 26. The pacing metric 194 may be global for all cores or core independent. The step of block 204 is now described in more detail with reference to steps of blocks 204-207.

The processing circuitry 24 is configured to apply (block 204) the artificial intelligence model 160 to find the pacing action 192 responsively to at least one previous state (such as a window of previous states) and at least one previous pacing action (such as a window of previous pacing actions) of the storage sub-system 26. The states of the storage sub-system 26 may be derived from actual state data of the storage sub-system 26 saved by the storage sub-system 26 or the processing circuitry 24. Each previous/current state of the storage sub-system 26 may include one or more of the following: a bandwidth of the storage sub-system 26; a cache hit rate of the storage sub-system 26; a pacing metric of the storage sub-system 26; and a number of buffers in flight over the storage sub-system 26; a cache eviction rate; a number of bytes waiting to be processed; number of bytes of transfer requests received over a given time window; a difference in a number of bytes in flight over the given time window; a number of bytes of the transfer requests completed over a given time window; and a number of bytes to submit over the given time window.

The processing circuitry 24 is configured to compute (block 205) the pacing metric 194 responsively to the pacing action 192. For example, the pacing metric 194 may be computed from the previous pacing metric plus the pacing action 192. In some embodiments, the pacing metric 194 is a pacing period, and the pacing action 192 is a change in the pacing period (from the previous pacing period).

The processing circuitry 24 is configured to manage transfer (block 206) of content between the remote device(s) 16 (FIG. 1) and the local peripheral storage devices 18 (FIG. 1) via the peripheral interface(s) 30 (FIG. 1) and the cache 34 (FIG. 1), responsively to the content transfer requests 42 (FIG. 4), while pacing the commencement of the serving of respective ones of the content transfer requests 42 responsively to the pacing metric 194 so that while ones of the content transfer requests 42 are being served, other ones of the content transfer requests 42 pending serving are queued in at least one pending queue 44 (FIG. 4).

The steps of blocks 204-206 are repeated for the next pacing period.

Reference is now made to FIG. 21, which is a flow diagram 210 illustrating an example method to use the trained pacing artificial intelligence model 160 of FIG. 19.

A number of states of the storage sub-system 26 in a window t−w to t—1, where t is a time period (e.g., the time period which is due to commence) and w is the size of the window, and a number of actions of the storage sub-system 26 in a window t−w to t−1 (block 212) are provided by system logs of the storage sub-system 26 or the processing circuitry 24. The window of states and actions are input into the pacing artificial intelligence model 160 yielding an action for time period t (block 214). The storage sub-system 26 then computes the pacing metric 194 (block 216) from the action for time period t and the previous pacing metric of time period t−1. The pacer is then run by the processing circuitry 24 to pace the content transfer requests 42 responsively to the pacing metric 194 (block 218) for time period t. The new state for time period t is found (block 220). For example, the new state for time period t may be retrieved from the system logs or other memory of the data communication apparatus 12.

The input data (block 212) to the artificial intelligence model 160 may then be updated by removing the oldest state and action from the window of states and actions and adding the newly computed state of time period t, and the action for time period t. The new input data is input into the artificial intelligence model 160 yielding a new action for the next time period (for time period t+1), and so on.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and sub-combinations of the various features described hereinabove, as well as variations and modifications thereof which would occur to persons skilled in the art upon reading the foregoing description and which are not disclosed in the prior art.

What is claimed is:

1. A processing apparatus, comprising a processor to train an artificial intelligence model to find a pacing action from which to derive a pacing metric for use in serving content transfer requests.

2. The apparatus according to claim 1, wherein the processor is configured to train the artificial intelligence model to find the pacing action from which to derive the pacing metric for use in pacing commencement of serving of the content transfer requests in a storage sub-system.

3. The apparatus according to claim 2, wherein the pacing metric is a pacing period.

4. The apparatus according to claim 3, wherein the pacing action is a change in pacing period to be applied by the storage sub-system.

5. The apparatus according to claim 2, wherein the processor is configured to train the artificial intelligence model to find the pacing action that maximizes at least one storage sub-system parameter responsively to training data including at least one previous storage sub-system state and at least one previous pacing action.

6. The apparatus according to claim 5, wherein the at least one storage sub-system parameter includes one or more of the following: a bandwidth; a cache hit rate; and a number of buffers in flight.

7. The apparatus according to claim 2, wherein the processor is configured to train the artificial intelligence model to find the pacing action that maximizes at least one storage sub-system parameter responsively to training data including at least one window of storage sub-system states and at least one window of pacing actions.

8. The apparatus according to claim 7, wherein the processor is configured to:
apply the artificial intelligence model to predict a plurality of future pacing actions responsively to training data including windows of storage sub-system states and windows of pacing actions;
apply the future pacing actions resulting in corresponding future storage sub-system states;
compute a reward or punishment responsively to comparing values of the at least one storage sub-system parameter of the future storage sub-system states with at least one target value; and
train the artificial intelligence model responsively to the reward or punishment.

9. The apparatus according to claim 8, wherein the processor is configured to apply a storage sub-system simulation engine that simulates operation of the storage sub-system to provide the future storage sub-system states responsively to the future pacing actions.

10. The apparatus according to claim 8, wherein each of the future storage sub-system states includes one or more of the following: a bandwidth; a cache hit rate; the pacing metric; a number of buffers in flight; a cache hit rate; the pacing metric; a number of buffers in flight; a cache eviction rate; a number of bytes waiting to be processed; a number of bytes of transfer requests received over a given time window; a difference in a number of bytes in flight over the given time window; a number of bytes of the transfer requests completed over a given time window; and a number of bytes to submit over the given time window.

11. The apparatus according to claim 2, wherein the processor is configured to find the pacing action from which to derive the pacing metric for use in pacing commencement of the serving of the content transfer requests in the storage sub-system responsively to reinforcement learning.

12. A processing apparatus, comprising processing circuitry to use an artificial intelligence model trained to find a pacing action from which to derive a pacing metric for use in serving content transfer requests.

13. The apparatus according to claim 12, wherein the processing circuitry is configured to use an artificial intelligence model trained to find the pacing action from which to derive the pacing metric for use in pacing commencement serving of the content transfer requests in a storage sub-system.

14. The apparatus according to claim 13, further comprising the storage sub-system, and wherein the processing circuitry is configured to:
pace the commencement of the serving of the content transfer requests responsively to the pacing metric;
apply the artificial intelligence model to find the pacing action; and
compute the pacing metric responsively to the pacing action.

15. The apparatus according to claim 14, further comprising a network interface comprising one or more ports for connection to a packet data network and configured to receive the content transfer requests from at least one remote device over the packet data network via the one or more ports, and wherein:
the storage sub-system is configured to be connected to local peripheral storage devices, and comprises at least one peripheral interface, and a memory sub-system comprising a cache and a random-access memory (RAM), the memory sub-system being configured to evict overflow from the cache to the RAM; and
the processing circuitry is configured to manage transfer of content between at least one remote device and the local peripheral storage devices via the at least one peripheral interface and the cache, responsively to the content transfer requests, while pacing the commencement of the serving of respective ones of the content transfer requests responsively to the pacing metric so that while ones of the content transfer requests are being served, other ones of the content transfer requests pending serving are queued in at least one pending queue.

16. The apparatus according to claim 13, wherein the pacing metric is a pacing period, and the pacing action is a change in the pacing period.

17. The apparatus according to claim 13, wherein the processing circuitry is configured to:
apply the artificial intelligence model to find the pacing action responsively to at least one previous state and at least one previous pacing action of the storage sub-system; and
compute the pacing metric responsively to the pacing action.

18. The apparatus according to claim 13, wherein the at least one previous state includes one or more of the following: a bandwidth of the storage sub-system; a cache hit rate of the storage sub-system; a pacing metric of the storage sub-system; and a number of buffers in flight over the storage sub-system; a cache eviction rate; a number of bytes waiting to be processed; a number of bytes of transfer requests received over a given time window; a difference in a number of bytes in flight over the given time window; a number of bytes of the transfer requests completed over a given time window; and a number of bytes to submit over the given time window.

19. The apparatus according to claim 13, wherein the processing circuitry is configured to:
apply the artificial intelligence model to find the pacing action responsively to a window of previous states and a window of previous pacing actions of the storage sub-system; and
compute the pacing metric responsively to the pacing action.

20. The apparatus according to claim 19, wherein each of the previous states includes one or more of the following: a bandwidth of the storage sub-system; a cache hit rate of the storage sub-system; a pacing metric of the storage sub-system; a number of buffers in flight over the storage sub-system; a cache eviction rate; a number of bytes waiting to be processed; a number of bytes of transfer requests received over a given time window; a difference in a number of bytes in flight over the given time window; a number of bytes of the transfer requests completed over a given time window; and a number of bytes to submit over the given time window.

21. A method, comprising:
receiving training data; and
training an artificial intelligence model to find a pacing action from which to derive a pacing metric for use in serving content transfer requests.

22. A method to use an artificial intelligence model trained to find a pacing action from which to derive a pacing metric for use in serving content transfer requests, the method comprising:
applying the artificial intelligence model to find the pacing action; and
computing the pacing metric responsively to the pacing action.

23. A software product, comprising a non-transient computer-readable medium in which program instructions are stored, which instructions, when read by a central processing unit (CPU), cause the CPU to:
receive training data; and
train an artificial intelligence model to find a pacing action from which to derive a pacing metric for use in serving content transfer requests.

24. A software product, comprising a non-transient computer-readable medium in which program instructions are stored, which instructions, when read by a central processing unit (CPU), cause the CPU to:
apply an artificial intelligence model to find a pacing action; and
compute a pacing metric for use in serving content transfer requests, responsively to the pacing action.
